(19) United States
(12) Patent Application Publication
(10) Pub. No.: US 2010/0305933 A1
(43) Pub. Date: Dec. 2, 2010

(54) Method and Apparatus for Verifying Logic Circuits Using Vector Emulation with Vector Substitution

(76) Inventors: Chioumin M. Chang, San Jose, CA (US); Thomas B. Huang, San Jose, CA (US); Huan-Chih Tsai, San Jose, CA (US); Ting-Mao Chang, Hsin-Chu (TW)

Correspondence Address: HAYNES AND BOONE, LLP;IP Section, 2323 Victory Avenue, Suite 700, Dallas, TX, 75219, US

(21) Appl. No.: 12/476,012

(22) Filed: Jun. 1, 2009

(51) Int. Cl. G06F 17/50

(52) U.S. Cl. 703/15

(57) ABSTRACT

A method for verifying a logic circuit in a prototyping system includes (a) configuring programmable logic circuits of the prototyping system to implement the logic circuit and to implement probe circuits for accessing internal nodes of the logic circuit; (b) preparing emulation vectors for use in a vector emulation of the logic circuit in the prototyping system; (c) setting one or more vector substitution points; (d) preparing one or more packet vectors at each vector substitution point for replacing emulation vectors in the vector emulation; (e) performing the vector emulation using the emulation vectors until one of the vector substitution points is reached; and (f) substituting packet vectors for the corresponding emulation vectors at vector substitution point and continuing the vector emulation.

### BACKGROUND OF THE INVENTION

1. Field of the Invention

The present invention relates to tools for designing an integrated circuit. In particular, the present invention relates to tools for verifying a logic circuit using an integrated prototyping system which implements the logic circuit in programmable logic circuits.

2. Discussion of the Related Art

FIG. 1 is a block diagram of conventional co-emulation system 100, including a host workstation 101 and emulation hardware 102. Co-emulation system 100 is suitable for use in verification of a logic circuit. As shown in FIG. 1, a portion 201c of a user's design may reside in software form (i.e., expressed in a hardware description language, such as “Verilog”) in workstation 101, and the remainder 205 of the design are compiled into the programmable logic circuits (referred to as the “device under verification” or DUV 205) of emulation hardware 102 (e.g., an emulation platform built using field programmable gate arrays, or “FPGAs”). Emulation hardware 102 is often used for prototyping.

FIG. 2 is a block diagram showing in greater details the elements of hardware and software environments in conventional co-emulation system 100. As shown in FIG. 2, in a co-emulation process, workstation 101 includes simulation system 201, which includes simulator 201a, test bench 201b and portion 201c of the user's design which is expressed in the hardware description language. Simulator 201a simulates the operations described in test bench 201b and portion 201c of the user's design. The simulation in simulator 201a is driven in part by the input stimulus and control signals provided by test bench 201b and portion 201c of the user's design. Simulator 201a also interacts with DUV 205 in emulation hardware 102. Typically, simulator 20 la generates stimuli and passes them to DUV 205 in emulation hardware 102 over a hardware interface (e.g., PCI bus 202) and receives responses from DUV 205 over the same hardware interface. As shown in FIG. 2, the hardware interface may include PCI interface circuits 202a and 202b, provided on workstation 101 and emulation hardware 102, respectively.

In emulation hardware 102, data acquisition controller 203 receives stimuli from simulator 201a via PCI interface circuits 202. Acquisition controller 203 translates and routes the received stimuli to DUV 205 implemented on the programmable logic circuits 204. The stimuli may be provided to DUV 205 as test vectors.

FIG. 3 shows providing test vectors to a DUV in a circuit verification application from a test bench. As shown in FIG. 3, in an FPGA implementation, each test vector may be applied to one or more signals (e.g., “action” signals that encode control signals, data signals, and addresses which specify the routing of the data signals in the FPGAs). To verify the DUV, one or more sets of test vectors are applied to the DUV at specific time points (e.g., time points T1, T2 and T3). Beginning at each time point, a group of test vectors are applied over a number of clock cycles. The signals of the DUV responding to the stimuli from simulator 201a may be fed back to simulator 201a for evaluation, or to drive further simulation. In some applications, a large number of clock cycles must be executed before reaching a satisfactory verification coverage.

Because simulator 201a does not have the inherent parallel execution advantage of emulation hardware 102, the operations of simulation system 201 are limited by the substantially slower vector rate in simulator 201a, relative to the vector rate that can be achieved in emulation hardware 102. Thus, the ability to apply test vectors directly to the emulation hardware without intervention from simulator (often called “vector emulation”) would save a significant amount of time. Test vectors that are directly applied to the emulation hardware are referred as “emulation vectors.”

### SUMMARY

According to one embodiment of the present invention, a method for verifying a logic circuit in a prototyping system includes (a) configuring programmable logic circuits of the prototyping system to implement the logic circuit and to implement probe circuits for accessing internal nodes of the logic circuit; (b) preparing emulation vectors for use in a vector emulation of the logic circuit in the prototyping system; (c) setting one or more trigger conditions or time points as vector substitution points; (d) preparing one or more packet vectors for replacing a portion of emulation vectors at each vector substitution point in the vector emulation; (e) performing the vector emulation using the emulation vectors until one of the vector substitution point is reached; (f) substituting the packet vectors for the corresponding emulation vectors at the vector substitution point; and (g) continuing the vector emulation. The method may be extended to include resuming the vector emulation using emulation vectors until a next vector substitution point is reached; and substituting the packet vectors for the corresponding emulation vectors at that next vector substitution point; and continuing the vector emulation. Such steps of resuming vector emulation, substituting packet vectors at the vector substitution point, and continuing vector emulation may be repeated until all emulation vectors are exhausted.

During a vector emulation, the clock signals in the logic circuit may be mapped to a reference clock signal which is used as a time base for all clock signals in the prototyping system. The packet vectors substituting emulation vectors may result in a different duration of vector emulation than the duration resulting from the emulation vectors being substituted. Probe circuits may be specified by a user through a workstation communicating with the prototyping system or may be automatically generated.

According to one embodiment of the present invention, emulation vectors may be extracted from stimuli to the logic circuit and responses from the logic circuit in a co-emulation system. The prototyping system may be a part of that co-emulation system. The emulation vector may be extracted from stimuli to and responses from one or more emulations conducted in the prototyping system. Alternatively, the emulation vectors may be generated in a vector generator. The packet vectors may be received from a workstation communicating with the prototyping system. A user may specify the packet vectors through the workstation. Alternatively, a test bench module running on the workstation may provide the packet vectors. The packet vectors may be generated in a vector generator. The packet vectors may also be extracted from one or more emulations conducted using the prototyping system.

The present invention is better understood upon consideration of the detailed description below, in conjunction with the accompanying drawings.

### BRIEF DESCRIPTION OF THE DRAWINGS

FIG. 1 is a block diagram of conventional co-emulation system 100, including a host workstation 101 and emulation hardware 102.

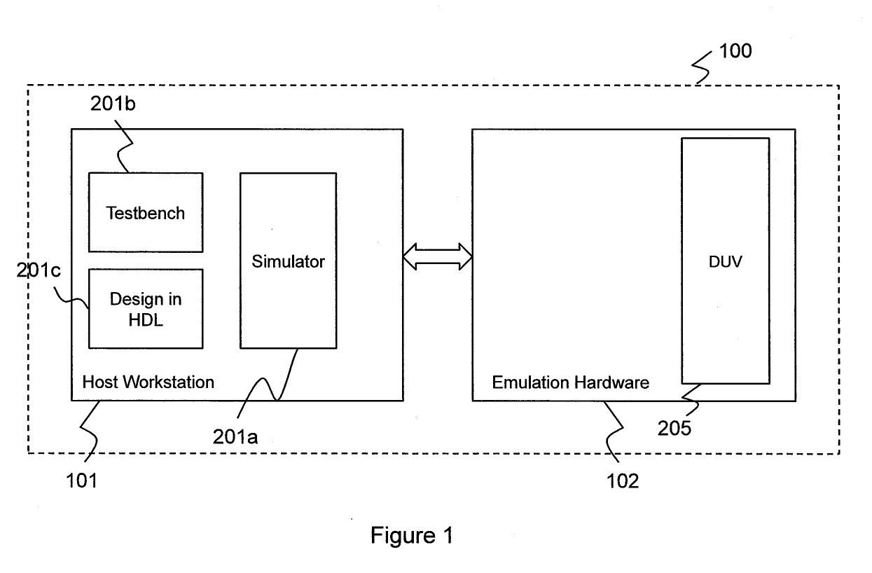

FIG. 2 is a block diagram showing in greater details the elements of hardware and software environments in conventional co-emulation system 100.

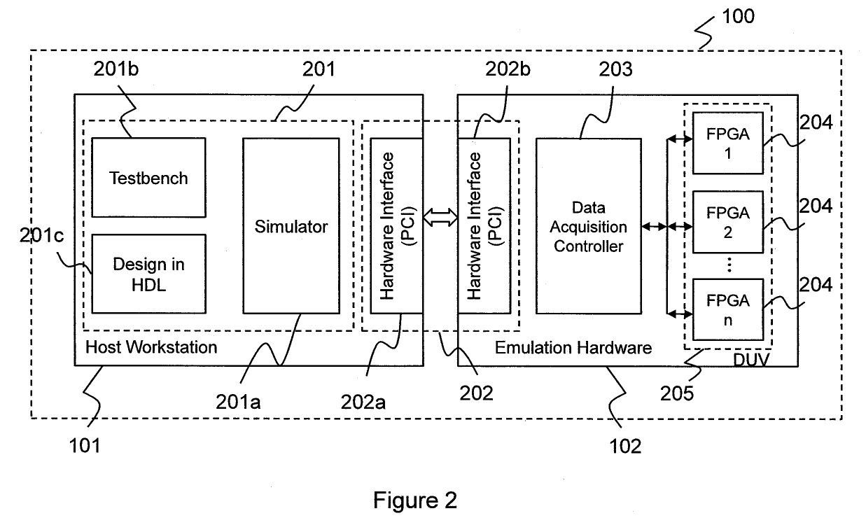

FIG. 3 shows providing test vectors to a DUV from a test bench in a circuit verification application.

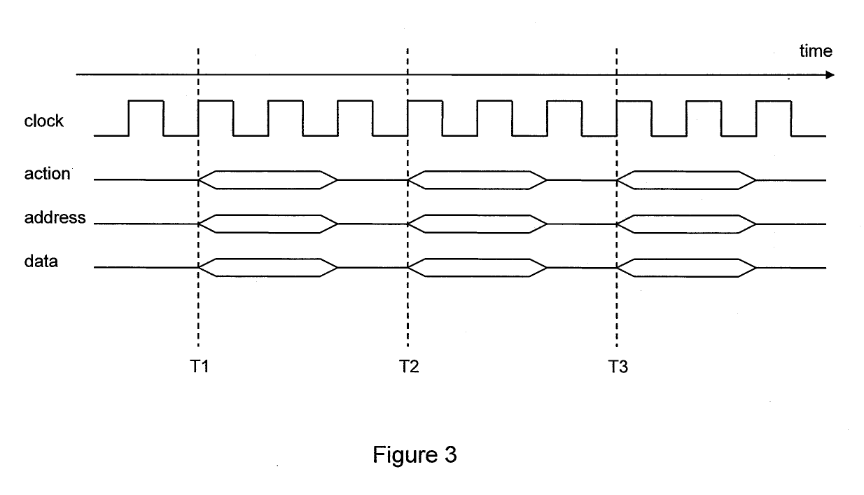

FIG. 4 shows vector emulation examples 4(b) and 4(c) with vector substitution, in accordance with one embodiment of the present invention.

FIG. 5 shows flow chart 500 illustrating a vector emulation with vector substitution, in accordance with one embodiment of the present invention.

### DETAILED DESCRIPTION OF THE PREFERRED EMBODIMENTS

The present invention may be implemented in an integrated prototyping system such as the type of prototyping systems that are described in copending patent applications (“Copending Applications”): (a) U.S. non-provisional patent application, entitled “Method of Progressively Prototyping and Validating a Customer's Electronic System Design,” Ser. No. 11/953,366, filed on Dec. 10, 2007, and (b) U.S. non-provisional patent application, entitled “Integrated Prototyping System For Validating An Electronic System Design,” Ser. No. 12/110,233, filed on Apr. 25, 2008. The disclosures of the Copending Applications are hereby incorporated by reference in their entireties. In addition, the present invention takes advantage of the “vector emulation” technique disclosed in copending patent application (the “Vector Emulation Application”), entitled “Method and Apparatus for Debugging an Electronic System Design (ESD) Prototype,” Ser. No. 12/255,606, filed on Oct. 21, 2008. The disclosure of the Vector Emulation Application is also hereby incorporated by reference in its entirety.

During an emulation, a snapshot is taken of the state variables of the DUV at a specified time point, and the input stimuli to the DUV and the output responses of the DUV for each clock period thereafter are captured and stored in a captured vector database. These captured values are available for subsequent retrieval as “emulation vectors.” The emulation vectors may be extracted using conventional co-emulation, or from stimuli and responses of the DUV implemented in the integrated prototyping system. The emulation vectors may also be generated using a vector generator. These emulation vectors are used in subsequent vector emulations. During each vector emulation session (e.g., during a debugging session), the waveforms of selected internal nodes of the DUV which are not specifically probed in the prototyping system may be constructed to provide visibility into internal nodes. Multiple vector emulation sessions may be used during a debugging process. The emulation vectors may be repeatedly used in multiple vector emulation sessions, so long as the circuit configurations in the prototyping system are not modified.

In a debugging application, for example, a user of an integrated prototyping system (IPS), such as any of those disclosed in the Copending Applications, may specify a number of clock cycles (e.g., advance the emulation back to a time point of interest) for the duration of a vector emulation session, or may specify a trigger condition which satisfaction terminates the vector emulation. The emulation vectors are preferably specified relative to a system reference clock signal, rather than the numerous clock signals typically found in the DUV. During vector emulation, signal values at user-defined probe points and automatically generated probe points, and the state values of low-latency snapshots may be captured, which may be used to carry out bounded-cycle simulations. Bounded-cycle simulations are disclosed in the Vector Emulation Application. (In bounded-cycle simulation, sequential loops are eliminated and a simulation is carried out into loop-free resulting circuit for a specified sequential depth).

As disclosed in the copending Vector Emulation Application, vector emulation may be carried out as “probe-based vector emulations,” “snapshot based vector emulations,” or various variations of such techniques (referred to as “hybrid vector emulations”).

In each iteration of a probe-based vector emulation, the user specifies new points at which signal values are to be observed and new assertions to check. The integrated prototyping system then generates a set of required probe points, including selected ones of the user-specified probe points and the automatically generated probe points. The required user-specified probe points and the system-generated probe points are then configured into the prototyping system. Vector emulation is then carried out in the prototyping system using the reference clock for the required number of cycles, or until a vector substitution point is reached, using the previously captured emulation vectors. During the vector emulation, the signal values at the user-specified probe points and the system-generated probe points are recorded for each reference clock cycle.

In each iteration of a snapshot-based vector emulation, the user specifies new probe or observation points for signal values to observe and new assertions to check. The integrated prototyping system then generates a set of required user-specified probe points and a set of required low-latency snapshots. The selected user-specified probe points and snapshot controls are then configured into the prototyping system. Vector emulation is then carried out in the prototyping system using the reference clock for the required number of cycles, or until a vector substitution point is reached, using the previously captured emulation vectors. During the emulation, the signal values at the probes are recorded for each reference clock cycle, together with the values of the state variables specified in the low-latency snapshots.

As mentioned above, vector emulation may be carried out with a set of events each corresponding to a vector substitution point. The vector substitution point may be a specific time point or satisfaction of a trigger condition. The specific time point may be relative to the reference clock. The trigger condition may be expressed as a logic expression based on specified signals. A complex trigger condition may be specified as a sequence of trigger conditions. The complex trigger condition is triggered when all the component trigger conditions are satisfied. In some applications, the component trigger conditions may be required to be satisfied in a predetermined order. According to one embodiment of the present invention, when such a trigger condition is satisfied, one or more emulation vectors from that time point forward (e.g., for a specified number of reference clock cycles) may be substituted by an alternative set of test vectors, referred to as “packet vectors.” The vector substitution point may be specified by a user, extracted from a test bench or extracted from events identified in the DUV implemented on the integrated prototyping system. The packet vectors used in the substitution represent alternative test conditions. The responses of the DUV to the packet vectors are captured for analysis and as part of further verification of the DUV. In this manner, verification of the DUV may be carried out entirely in the integrated prototyping system without interaction by either the simulator or the test bench, resulting in great time-savings (e.g., several orders of magnitude in elapsed time required over conventional co-emulation).

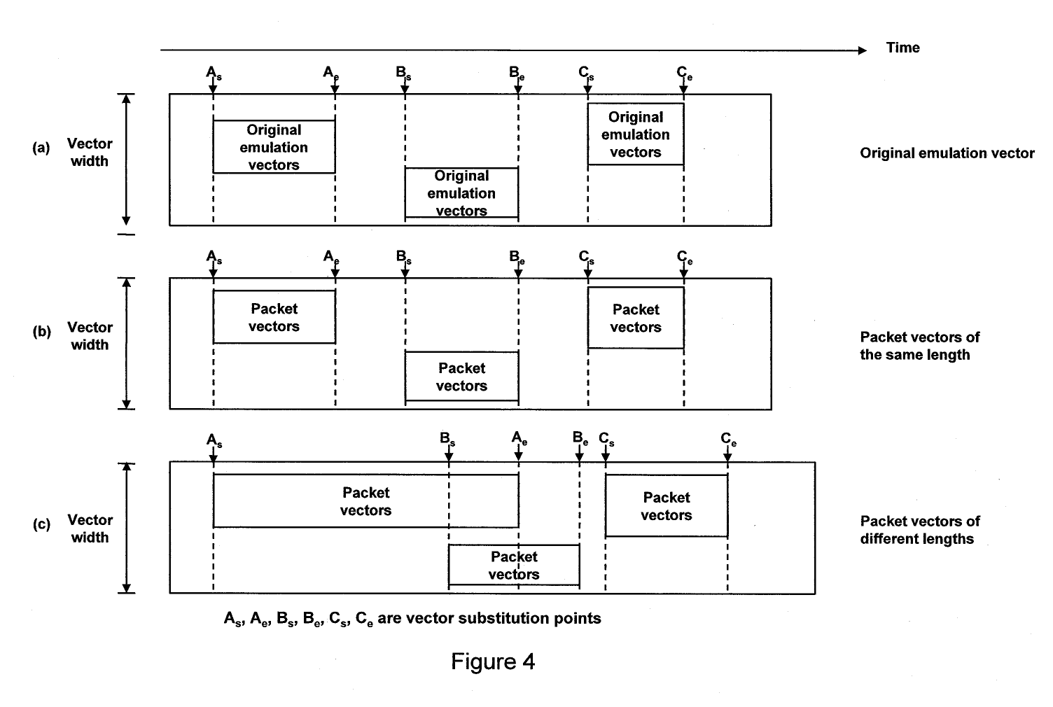

FIG. 4 shows emulation vector examples with vector substitution, in accordance with one embodiment of the present invention. Example 4(a) represents a vector emulation in which the emulation vectors for each of time intervals (Aₛ, Aₑ), (Bₛ, Bₑ) and (Cₛ, Cₑ) may be substituted by alternative packet vectors. Example 4(b) represents substituting packet vectors for the emulation vectors of example 4(a) over the same time intervals (Aₛ, Aₑ), (Bₛ, Bₑ) and (Cₛ, Cₑ). Alternatively, as shown in example 4(c), packet vectors may be provided that results in a different number of reference clock cycles than that the number of reference clock cycles resulting from the emulation vectors being substituted.

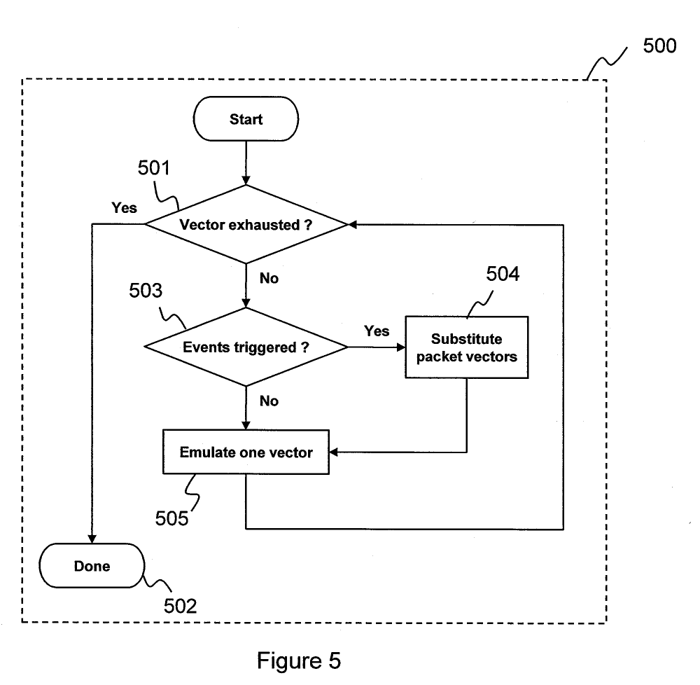

FIG. 5 shows flow chart 500 illustrating a vector emulation with vector substitution, in accordance with one embodiment of the present invention. Emulation vectors are prepared in advance and may be updated in the course of performing vector emulation. At step 501, the integrated prototyping system determines if the emulation vectors have been exhausted (i.e., the vector emulation is complete). If the emulation vectors have been exhausted, the vector emulation is terminated (step 502). Otherwise, at step 503, the integrated prototyping system examines trigger conditions. If a triggering condition is satisfied, packet vectors are retrieved to replace the emulation vectors at step 504. At step 505, the integrated prototyping system emulates one vector on DUV then returns to step 501 for the next iteration.

The detailed description above is provided to illustrate the specific embodiments of the present invention and is not intended to be limiting. Numerous variations and modifications within the scope of the present invention are possible. The present invention is set forth in the following claims.

We claim:

1. A method for verification of a logic circuit in a prototyping system, comprising;
configuring programmable logic circuits of the prototyping system to implement the logic circuit and to implement probe circuits for accessing internal nodes of the logic circuit;
preparing emulation vectors for use in a vector emulation of the logic circuit in the prototyping system;
setting one or more vector substitution points for the vector emulation;
preparing one or more packet vectors corresponding to each vector substitution point for the vector emulation;
performing the vector emulation for the logic circuit using the emulation vectors until one of the vector substitution points is reached;
substituting the packet vectors for the corresponding emulation vectors at the vector substitution point; and
continuing the vector emulation.

2. The method of claim 1, further comprising:
resuming the vector emulation using the emulation vectors until a next vector substitution point is reached;
substituting packet vectors for the corresponding emulation vectors at that next vector substitution point; and
continuing the vector emulation.

3. The method of claim 2, further comprising repeating the steps of resuming the vector emulation, substituting packet vectors and continuing the vector emulation until all emulation vectors are exhausted.

4. The method of claim 1, wherein substituting the packet vectors results in the same duration of vector emulation as the duration provided by the emulation vectors being substituted.

5. The method of claim 1, wherein substituting the packet vectors results in a different duration of vector emulation than the duration of the vector emulation resulting from the emulation vectors being substituted.

6. The method of claim 1 wherein, during the vector emulation, clock signals in the logic circuit are mapped into a reference clock signal.

7. The method of claim 1, wherein the probe circuits are specified by a user through a workstation communicating with the prototyping system.

8. The method of claim 1, wherein the probe circuits are automatically generated.

9. The method of claim 1, wherein preparing emulation vectors comprises extracting stimuli to the logic circuit and responses from the logic circuit in a co-emulation system.

10. The method of claim 9, wherein the prototyping system is a part of the co-emulation system.

11. The method of claim 1, wherein preparing emulation vectors comprises extracting stimuli and responses from one or more emulations conducted using the prototyping system.

12. The method of claim 1, wherein preparing emulation vectors comprises generation of the emulation vectors using a vector generator.

13. The method of claim 1, wherein preparing packet vectors comprises receiving test vectors from a workstation communicating with the prototyping system.

14. The method of claim 13, wherein the packet vectors are specified by a user at the workstation.

15. The method of claim 13, wherein the packet vectors are provided by a test bench module running on the workstation.

16. The method of claim 1, wherein preparing packet vectors comprises generating the packet vectors using a vector generator.

17. The method of claim 1, wherein preparing the packet vectors comprises extracting vectors from one or more emulations conducted using the prototyping system.

18. The method of claim 1, wherein one or more of the vector substitution points is specified by a trigger condition that is implemented by a logic expression.

19. The method of claim 1, wherein one or more of the vector substitution points is specified by a trigger condition that is specified as a sequence of events to be satisfied in a predetermined order.

20. The method of claim 1, wherein one or more of the vector substitution points is specified as a trigger condition which determines time points between which packet vectors are substituted for emulation vectors.
